(19) United States
(12) Patent Application Publication
(10) Pub. No.: US 2008/0101196 A1
(43) Pub. Date: May 1, 2008

(54) APPARATUS AND METHOD FOR RECORD AND/OR REPRODUCE HOLOGRAPHIC INFORMATION

(75) Inventors: Taek-seong Jeong, Suwon-si (KR); Jong-chul Choi, Suwon-si (KR); Moon-Il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/733,457

(22) Filed: Apr. 10, 2007

(30) Foreign Application Priority Data
Oct. 25, 2006 (KR) 2006-103895

(51) Int. Cl. G11B 7/00

(52) U.S. Cl. 369/103

(57) ABSTRACT

An apparatus and a method to record and/or reproduce holographic information includes a light source to generate a light beam, a first beam splitter to split the light beam generated by the light source into two light beams, a signal beam component to modulate one of the two split light beams into a signal beam having a two-dimensional signal pattern and to transmit the signal beam to the holographic recording medium, a reference beam component to transmit the other of the two split light beams as a reference beam to the holographic recording medium, a two-dimensional photodetector to detect the signal beam reproduced from the holographic recording medium, and an aperture to restrict the width of the signal beam, wherein while information is recorded and/or reproduced in one region of the holographic recording medium, the aperture is moved according to a rotation of the rotating holographic recording medium.

### CROSS-REFERENCE TO RELATED APPLICATION

This application claims the benefit of Korean Application No. 2006-103895, filed Oct. 25, 2006, in the Korean Intellectual Property Office, the disclosure of which is incorporated herein by reference.

### BACKGROUND OF THE INVENTION

1. Field of the Invention

Aspects of the present invention relate to an apparatus and a method to record and/or reproduce holographic information, and more particularly, to an apparatus to record and/or reproduce holographic information which includes an aperture to move along a rotation direction of a holographic recording medium, and a method to record and/or reproduce holographic information using the same.

2. Description of the Related Art

Hologram technology can reproduce an optical signal in a stereoscopic image by recording an interference pattern created between a signal beam which carries a signal and a reference beam reflected at a different angle from the signal beam. Optical storage technology for recording and reproducing digital data using holographic principles has recently become very important. Holographic information recording and reproducing technology allows recording and reproducing in units of pages by which digital data are simultaneously recorded and reproduced in the shape of a two-dimensional image. Thus, an ultra-high speed recording and reproducing system can be implemented.

In addition, holographic optical storage technology can even separate and read information which is spatially overlapped and stored by using a proper multiplexing technique. Thus, data information of several pages can be recorded even if the pages overlap and are reproduced in the same region. In general, a two-dimensional region which is a unit for information recording and reproducing in a holographic recording medium is referred to as a “book,” and information of several pages is recorded in one book. In order to increase recording density, it is important to minimize the distance between books.

FIG. 1A schematically illustrates the principle of recording information using holographic technology. As illustrated in FIG. 1A, a beam splitter 2 splits a laser beam 1 into a reference beam 6 and a signal beam 5. The signal beam 5 passes a spatial light modulator (SLM), is modulated into a two-dimensional signal pattern, and is then incident on a holographic recording medium D. Meanwhile, the reference beam 6 is reflected by a mirror 3 and is incident on the holographic recording medium D at an angle relative to the signal beam 5, causing the reference beam 6 to interfere with the signal beam 5. An interference pattern formed in this way is recorded on the holographic recording medium D.

FIG. 1B illustrates the principle of reproducing recorded information using a hologram. When information is reproduced, the signal beam 5 is irradiated on the holographic recording medium D using a laser 8 to emit a laser beam having the same wavelength as the reference beam 6. Here, the reference beam 6 should be incident on the holographic recording medium D at the same angle of incidence as when information was recorded. However, in order to form a light-transmitting portion and a light-receiving portion of the signal beam 5 as a unitary body and to minimize the effect of lens aberration, when information is reproduced, the reference beam 6 travels in the opposite direction as the direction which the reference beam 6 travels when information is recorded, as illustrated in FIG. 1B. This reproducing technique is referred to as a conjugation reproducing technique.

To implement the conjugation reproducing technique, an additional structure is needed to direct the reference beam 6 in the opposite direction. A signal beam reproduced using this technique becomes a two-dimensional signal pattern containing the original data information. The signal beam is condensed by a lens 9 and detected by a detector 10, such as a charge coupled device (CCD). Since the size of the reference beam is generally larger than the size of one book, a signal reproduced from another book is also included in the signal beam reproduced by the reference beam. Thus, in order to prevent interference between the signals, an aperture of the same size as one book is located in the path of the signal beam, so that only the desired signal is detected by the detector 10 and other signals are cut off, as illustrated in FIG. 1B.

In the case of a conventional holographic information recording and/or reproducing apparatus, recording and/or reproducing is performed while the holographic recording medium D is still. That is, recording and/or reproducing of information is performed in one book while the holographic recording medium D is stopped, and then the holographic recording medium D is moved so that recording and/or reproducing can be performed in the next book. Thus, the holographic recording medium D undergoes stop-and-go motion during recording and/or reproducing. However, this continuous acceleration and deceleration causes mechanical wear, and high mechanical precision is needed.

To avoid these problems, techniques have been suggested to rotate a recording medium at a high speed during recording and reproducing operations, similar to the techniques used to record and reproduce data to and from the current compact discs (CDs) and digital versatile discs (DVDs). That is, as illustrated in FIG. 2, the holographic recording medium D is rotated, an optical pickup (not shown) is moved radially across the holographic recording medium D, a reference beam is irradiated onto the holographic recording medium D, and information is recorded and/or reproduced to and/or from the holographic recording medium n

However, when the holographic recording medium D is continuously rotated, the signal beam reproduced from the holographic recording medium D passes the CCD at a very high speed. Thus, recording and reproducing of information must be performed within a very short time. For example, FIG. 3 illustrates the intensity of a signal beam continuously reproduced. The curve illustrated in FIG. 3 shows the sum of the intensities of signal beams detected by a two-dimensional photodetector, such as a CCD, according to time. The peaks in the curve represent signal beams reproduced from books disposed along the circumferential direction of the holographic recording medium D. The box indicated by a dotted line represents the time frame when the CCD detects the reproduction signal of each book.

As illustrated in FIG. 3, the time t₁ during which the CCD can detect one book is only a small fraction of the entire time T when reproduction signals are output. Thus, since the CCD receives a signal beam during only a very short time, it is difficult to perform exact reproduction. To solve this problem, a light source having a very high output should be used, or the rotation speed of the holographic recording medium D should be reduced and the distance between books should be increased to allow sufficient time for recording and reproducing. However, these conventional methods are expensive and can only achieve low recording capacity.

### SUMMARY OF THE INVENTION

Aspects of the present invention provide an apparatus and a method to record and/or reproduce holographic information by which information can be effectively recorded and reproduced while rotating a holographic recording medium.

Additional aspects and/or advantages of the invention will be set forth in part in the description which follows and, in part, will be obvious from the description, or may be learned by practice of the invention.

According to an aspect of the present invention, an apparatus to record and/or reproduce holographic information to and/or from a rotating holographic recording medium includes a light source to generate a light beam, a first beam splitter to split the light beam generated by the light source into one light beam and another light beam, a signal beam component to modulate the one light beam into a signal beam having a two-dimensional signal pattern and to transmit the signal beam along an optical path to the holographic recording medium, a reference beam component to transmit the other light beam as a reference beam to the holographic recording medium, a two-dimensional photodetector to detect the signal beam reproduced from the holographic recording medium, and an aperture to restrict a width of the signal beam, wherein while information is recorded to and/or reproduced from one region of the holographic recording medium, the aperture is be moved according to a rotation of the rotating holographic recording medium.

According to an aspect, after the recording and/or reproducing of the information in the one region is completed, the aperture may return to an initial position to perform recording and/or reproducing of additional information in a next region.

According to an aspect, the signal beam component includes a spatial light modulator to modulate the one light beam into the signal beam having a two-dimensional signal pattern, a second beam splitter to transmit the one light beam emitted from the first beam splitter toward the spatial light modulator and to transmit the signal beam emitted from the spatial light modulator toward the holographic recording medium, and an objective lens to focus the signal beam incident on the holographic recording medium.

According to an aspect, the aperture is located along the optical path of the signal beam between the second beam splitter and the objective lens.

According to an aspect, the second beam splitter transmits the signal beam reproduced from the holographic recording medium toward the two-dimensional photodetector.

According to an aspect, the two-dimensional photodetector is a CCD (charge coupled device).

According to an aspect, the aperture is a liquid crystal aperture in which a light transmission region is moved so that the light transmission region maintains a fixed position relative to the rotating holographic recording medium.

According to an aspect, the aperture may be a rotating disc including a plurality of openings formed along a circumferential direction of the rotating disc at predetermined intervals.

According to an aspect, the holographic recording medium is split into a plurality of information recording regions, and a prepit indicating a movement start time of the aperture is marked in each of the information recording regions.

According to an aspect, the apparatus further includes an aperture controller to control the movement of the aperture by detecting the prepit marks marked in each of the information recording regions of the holographic recording medium.

According to an aspect, the aperture controller includes an auxiliary light source to emit an auxiliary light beam to detect the prepit marks, a photodetector to detect the prepit marks from the auxiliary beam reflected by the holographic recording medium, a third beam splitter to transmit the auxiliary light beam from the auxiliary light source toward the holographic recording medium and to transmit the auxiliary light beam reflected from the holographic recording medium toward the photodetector, and an aperture driver to drive the aperture when each of the prepit marks is detected by the photodetector.

According to an aspect, the aperture controller further includes a fourth beam splitter to transmit the auxiliary light beam emitted from the auxiliary light source along the optical path of the signal beam.

According to an aspect, the photodetector is a photodiode.

According to another aspect of the present invention, a method to record and/or reproduce holographic information using an apparatus to record and/or reproduce holographic information to and/or from a rotating holographic recording medium, the apparatus including an aperture to restrict a width of a signal beam, includes rotating the holographic recording medium, moving the aperture according to a rotation of the rotating holographic recording medium while information is recorded and/or reproduced to and/or from one region of the holographic recording medium, and returning the aperture to an initial position after the recording and/or reproducing information of the information to and/or from the one region is completed, to perform recording and/or reproducing of additional information to and/or from a next region.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate the principle of a conventional apparatus to record and/or reproduce holographic information using hologram technology;

FIG. 2 illustrates the general principle of recording and/or reproducing information by rotating a holographic recording medium;

FIG. 3 shows reproducing times when information is reproduced from a rotating holographic recording medium using the conventional apparatus to record and/or reproduce holographic information shown in FIGS. 1A and 1B;

FIG. 4 shows the schematic structure of an apparatus to record and/or reproduce holographic information according to an embodiment of the present invention;

FIGS. 5(a), 5(b) and 5(c) illustrate the operation of moving an aperture to reproduce information using the apparatus to record and/or reproduce holographic information illustrated in FIG. 4;

FIG. 6 shows reproducing times when information is reproduced from a rotating holographic recording medium using the apparatus to record and/or reproduce holographic information illustrated in FIG. 4; and

FIGS. 7 and 8 respectively illustrate apertures according to embodiments of the present invention.

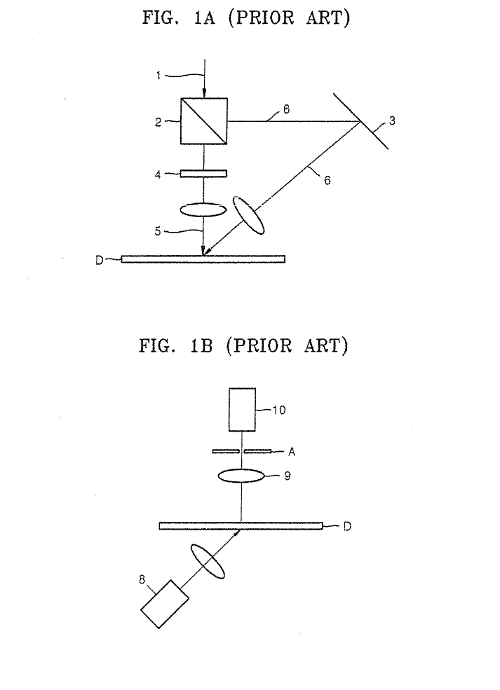

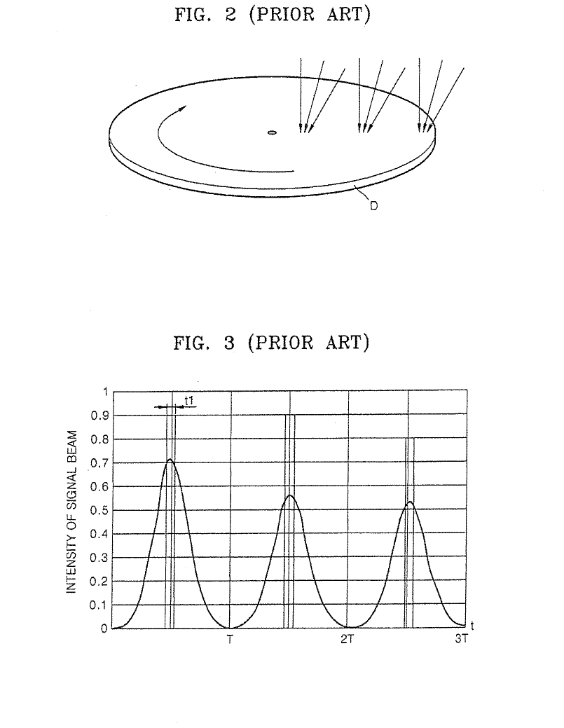

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

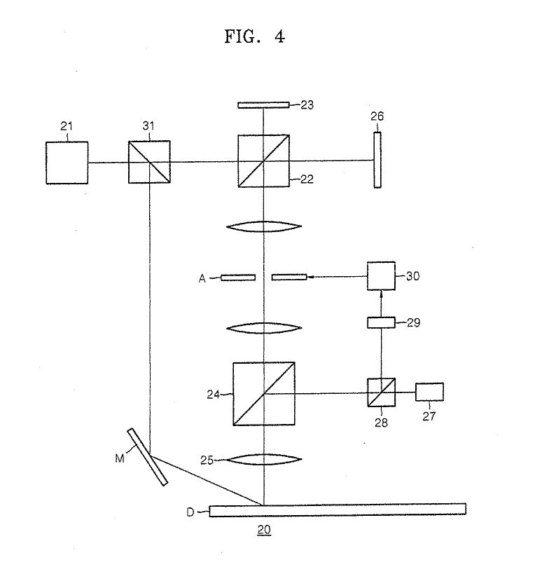

FIG. 4 shows the schematic structure of an apparatus 20 to record and/or reproduce holographic information according to an embodiment of the present invention. Referring to FIG. 4, the apparatus 20 to record and/or reproduce holographic information includes a light source 21 to generate a light beam, a first beam splitter 31 to split the light beam generated by the light source 21 into two light beams, a spatial light modulator (SLM) 23 to modulate incident light into a signal beam having a two-dimensional signal pattern, a second beam splitter 22 to transmit light emitted from the first beam splitter 31 toward the SLM 23 and to transmit the signal beam emitted from the SLM 23 toward the holographic recording medium D, an objective lens 25 to focus the signal beam incident on the holographic recording medium D, a mirror M to reflect one of the two beams transmitted from the first beam splitter 31 as a reference beam onto the reproduced from the recording medium D, and an aperture A to restrict the width of the signal beam. It is understood that the structure of the apparatus 20 shown in FIG. 4 may include other components instead of or in addition to the components shown in FIG. 4 and described above.

For explanatory conveniences, in FIG. 4, only a mirror M is shown as a component to reflect a reference beam to the holographic recording medium D at an angle of incidence. However, a more complicated structure to control the angle of incidence of the reference beam may instead be used. For example, according to well-known technology, two galvano-mirrors may also be used as a component to reflect the reference beam. A variety of technologies used to control the incidence angle of the reference beam are well-known, and thus a detailed description thereof will be omitted.

The second beam splitter 22, the SLM 23, and the objective lens 25 transmit a signal beam to the holographic recording medium D. According to an embodiment of the present invention, the aperture A to restrict the cross-sectional size of the signal beam may be located in the path of the signal beam between the second beam splitter 22 and the objective lens 25 along an optical path of the signal beam. However, it is understood that the aperture A may be located at other locations along the optical path of the signal beam, such as, for example, between the second beam splitter 22 and the two-dimensional photodetector 26.

As described above, the aperture A has the same size as a region (that is, a book) which is a unit to record information on the holographic recording medium D. Thus, the aperture A only transmits a signal reproduced from a desired region and cuts off signals reproduced from peripheral regions, to prevent interference between the desired signal and other signals. Here, the size of the aperture A may be adjusted based on various factors. For example, the size of the aperture A may be changed according to the magnification of lenses around the aperture A. For example, if the magnification of lenses around the aperture is 1, the aperture A should be configured to be the same size as one book. Additionally, if the size of one book changes, the aperture A should accordingly change as well.

The two-dimensional photodetector 26 to detect the reproduced signal beam is located on one side of the second beam splitter 22. The second beam splitter 22 transmits the signal beam reproduced from the holographic recording medium D toward the two-dimensional photodetector 26. Thus, the signal beam reproduced from one book passes through the reproduced signal beam has a two-dimensional signal pattern and thus can be detected only by the two-dimensional photodetector 26. The two-dimensional photodetector 26 may, for example, be constituted of a plurality of photodiodes arranged in an array. In addition, the two-dimensional photodetector 26 may be a charge coupled device (CCD). It is understood that the two-dimensional photodetector 26 may take various forms which are known in the art.

According to aspects of the present invention, the holographic recording medium D may be continuously rotated at a high speed, like a compact disc (CD) or digital versatile disc (DVD). To this end, although not shown in FIG. 4, the apparatus 20 to record and/or reproduce holographic information may further include a spindle motor to rotate the holographic recording medium D, an optical pickup installed to move in the radial direction of the holographic recording medium D which records and/or reproduces information to and/or from the holographic recording medium D, a driver to drive the spindle motor, a controller to control focusing and tracking servos of the optical pickup, a turntable on which the holographic recording medium D is mounted, and a clamp to hold the holographic recording medium D. This configuration uses a conventional driving apparatus to rotate an optical recording medium, and thus a detailed description thereof will be omitted.

As described above, when the holographic recording medium D is rotated, a signal reproduced from one book passes the aperture A within a very short time and is incident on the two-dimensional photodetector 26, and subsequently, a signal beam reproduced from the next book along the circumferential direction of the holographic recording medium D is incident on the two-dimensional photodetector 26. Thus, according to the conventional technology, since the time when a reproduced signal beam of one book can be detected is very short, the intensity of the reference beam or the distance between books must increase to allow exact detection.

Aspects of the present invention propose a method of moving the aperture A to solve the problems associated with the conventional technology. Specifically, as the holographic recording medium D is rotated, the aperture A is also rotated so that its position relative to the rotating holographic recording medium D does not change. Since the aperture A is rotated according to the rotation of the holographic recording medium D, the time available to record and reproduce data to and from one recording region (that is, one book) can be increased.

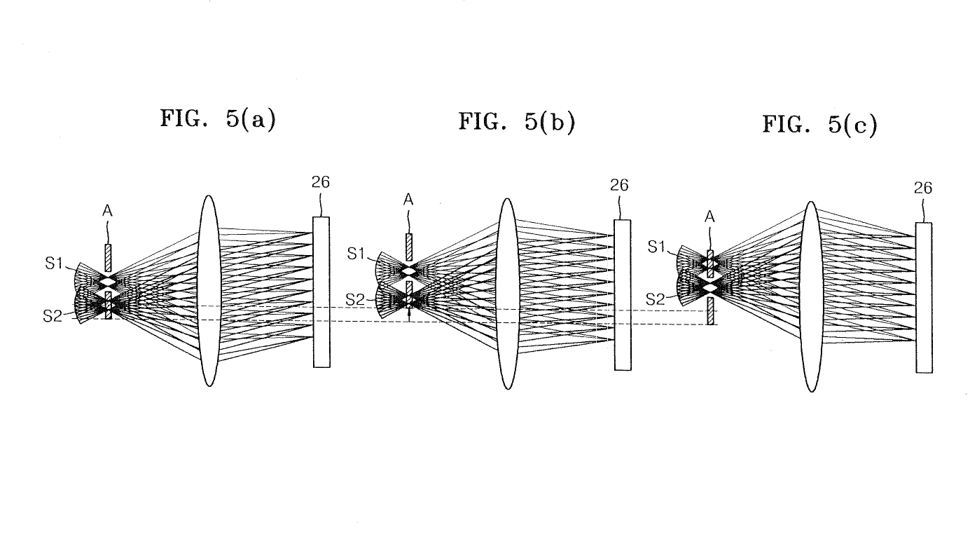

FIGS. 5(a), 5(b) and 5(c) illustrate the principle of increasing the recording and reproducing time of one recording region by moving the aperture A using the apparatus 20 to record and/or reproduce holographic information illustrated in FIG. 4. Referring to FIGS. 5(a), 5(b) and 5(c), signals S1 and S2 are continuously reproduced along the circumferential direction of the holographic recording medium D. In the drawing, it is assumed that the holographic recording medium D rotates upward on the page, in other words, that an upward movement on the page corresponds to a circumferential movement of the rotating holographic recording medium D. First, referring to FIG. 5(a), a first signal S1 passes the aperture A in an initial position and starts being incident on the two-dimensional photodetector 26. As the holographic recording medium D rotates, the first signal S1 also moves upward. As illustrated in FIG. 5(b), the aperture A also moves upward at the same speed, so that the time for which the first signal S1 passes through the aperture A and is incident on the two-dimensional photodetector 26 is increased. The aperture A moves in this way to allow sufficient time for the two-dimensional photodetector 26 to detect a signal beam. Then, as illustrated in FIG. 5(c), after detecting the first signal S1, the aperture A returns to its initial position, and the above operations are repeated for a second signal S2. It is understood that the aperture A may be used with more than two signals.

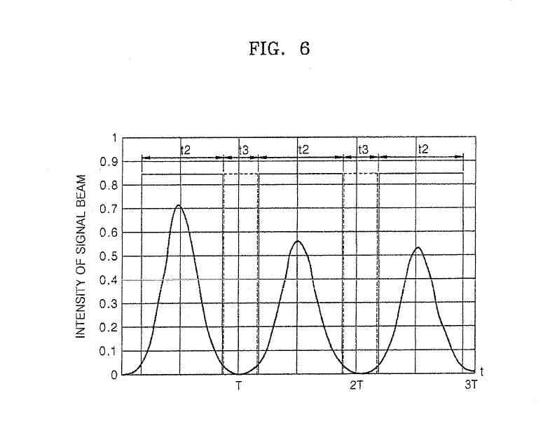

By repeating the above operations, the two-dimensional photodetector 26 can detect a signal beam during a time t2 indicated by a box in FIG. 6. The time t2 according to aspects of the present invention is much longer than the conventional detection time t1 illustrated in FIG. 3. Thus, according to aspects of the present invention, a signal beam can be reproduced without increasing the intensity of the reference beam or increasing the distance between books. The aperture A moves during the time t2 and then returns to its original position during the time t3 to be ready to trace the next signal beam for another period of time t2.

In the apparatus 20 to record and/or reproduce holographic information illustrated in FIG. 4, the speed and distance of movement of the aperture A can be calculated as follows. If the objective lens 25 has a numerical aperture (NA) of 0.6 and a focusing distance of 15 mm, and the SLM 23 has a pixel size of 13×13 μm, then the width of one recording region (that is, a book) of the holographic recording medium D is about 700 μm. As a result, the width of the aperture A should also be about 700 μm. In this case, a movement distance of the aperture A should be about 500 μm, which is slightly less than the width of the recording region.

The movement speed of the aperture A is determined according to the rotation speed of the holographic recording medium D. The rotation speed of the holographic recording medium D changes according to the data transfer rate (DTR) which is intended to be achieved. For example, when the capacity of one page is 1 megabit and a code rate is 50%, 320 pages must be reproduced per second to achieve a DTR of 160 Mbps. In this case, the time between pages is about 3 ms and the rotation speed of the continuously-rotating holographic recording medium D is about 0.3 m/s. In another example, when the capacity of one page is 1 megabit, the code rate is 50%, and the desired DTR is 1 Gbps, 2000 pages must be reproduced per second. In this case, the time between pages is about 0.5 ms and the rotation speed of the holographic recording medium D is about 1.5 m/s. According to aspects of the present invention, the movement speed of the aperture A can be the same as the above-described rotation speed of the holographic recording medium D. When the error of the relative position between the aperture A and the holographic recording medium D is kept within 50 μm, there is no problem with accurately recording or reproducing a signal beam.

In order to keep the relative position between the recording region of the holographic recording medium D and the aperture A within the above-described error range of 50 μm, the aperture A should be moved exactly in synchronization with the recording region. To this end, a prepit indicating the movement start time of the aperture A may be marked in each information recording region of the holographic recording medium D. Also, the apparatus 20 to record and/or reproduce holographic information illustrated in FIG. 4 may further include an aperture controller to control the movement of the aperture A by detecting the prepit mark of each information recording region of the holographic recording medium D.

For example, referring to FIG. 4, the aperture controller according to aspects of the present invention may include an auxiliary light source 27 which emits an auxiliary beam to detect the prepit mark, a photodetector 30 which detects the prepit mark from the auxiliary beam reflected from the holographic recording medium D, a third beam splitter 28 which directs the auxiliary beam from the auxiliary light source 27 toward the holographic recording medium D and directs the auxiliary beam reflected from the holographic recording medium D toward the photodetector 29, and an aperture driver 30 which drives the aperture A according to the prepit marks detected by the photodetector 29. The auxiliary beam emitted from the auxiliary light source 27 is coupled to the optical path of the signal beam by a fourth beam splitter 24. Here, the photodetector 29 to detect prepits does not need to be a two-dimensional photodetector and may instead only have one photodiode. It is understood that the aperture controller is not limited to the configuration shown in FIG. 4 and described above. For example, the third beam splitter 28 may be removed and the photodetector 29 may then be located next to the auxiliary light source 27.

In the structure shown in FIG. 4, the auxiliary beam emitted from the auxiliary light source 27 passes the third beam splitter 28 and is reflected by the fourth beam splitter 24. After that, the auxiliary beam is incident on the holographic recording medium D along the same path as the signal beam. Next, the auxiliary beam is reflected from the holographic recording medium D and reflected by the fourth beam splitter 24 and the third beam splitter 28 to strike the photodetector 29. If a prepit mark is detected by the photodetector 29, the aperture driver 30 moves the aperture A to record and/or reproduce information to the holographic recording medium D. Then, the aperture A moves a predetermined distance and returns to its initial position.

According to aspects of the present invention, the movable aperture A may have various shapes. For example, the movable aperture A may include a flat board (not shown) in which one opening is formed, and an actuator to reciprocate the flat board horizontally. According to this flat board design, the actuator reciprocates to move the opening in a circumferential direction of the rotating holographic recording medium D, thereby maintaining a constant position between the desired recording/and or reproducing region and the one opening.

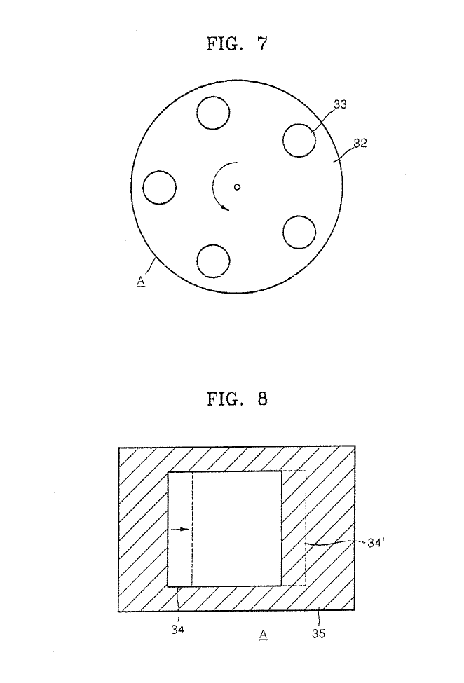

Alternatively, the aperture A may include a rotating disc 32 in which a plurality of openings 33 are formed in its circumferential direction at predetermined intervals, and a stepping motor (not shown) to rotate the disc 32, as illustrated in FIG. 7. According to an aspect of the invention, the disc 32 rotates at a constant speed so that recording regions of the rotating holographic recording medium D continuously coincide with the openings 33. Alternatively, the disc 32 may repeatedly rotate a predetermined circumferential distance and stop according to the control of the aperture driver 30. In addition, the aperture A may also be electrically constituted using liquid crystals, instead of having a physical structure. For example, the aperture A may have a light transmission region of a liquid crystal panel 35 which can move from an initial region 34 to another region 34′ along the holographic recording medium D, as illustrated in FIG. 8. It is understood that the aperture A is not limited to these above designs. The aperture A may be designed in many different ways, as long as the aperture includes a portion which transmits light and is movable to maintain a fixed position relative to the rotating holographic recording medium D.

The description above has focused mainly on reproducing the signal beam from the holographic recording medium D. However, the same principle may be applied to recording the signal beam on the holographic recording medium D. However, when the signal beam is recorded on the holographic recording medium D, the signal beam needs to trace a recording region of the rotating holographic recording medium D. Thus, the angle of the signal beam reflected by the SLM 23 is continuously changed according to movement of the holographic recording medium D. Similarly, the aperture A is moved while keeping its position relative to the holographic recording medium D within a predetermined range. As a result, recording time is increased and exact recording is possible without needing to increase the intensity of a light beam or the distance between recording regions.

According to aspects of the present invention, the aperture A is moved along with the rotating holographic recording medium D to increase the time available to record data to and reproduce data from the holographic recording medium D. Thus, even when the holographic recording medium D is rotated and information is recorded and reproduced, neither the intensity of the light beam nor the distance between recording regions needs to be increased. Thus, using the apparatus and method according to aspects of the present invention enables a user to precisely record data to and/or reproduce data from a holographic recording medium without increasing manufacturing costs or reducing the recording capacity of the holographic recording medium.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to record and/or reproduce holographic information to and/or from a rotating holographic recording medium, the apparatus comprising:
a light source to generate a light beam;
a first beam splitter to split the light beam generated by the light source into one light beam and another light beam;
a signal beam component to modulate the one light beam into a signal beam having a two-dimensional signal pattern and to transmit the signal beam along an optical path to the holographic recording medium;
a reference beam component to transmit the other light beam as a reference beam to the holographic recording medium;
a two-dimensional photodetector to detect the signal beam reproduced from the holographic recording medium; and
an aperture to restrict a width of the signal beam,
wherein while information is recorded to and/or reproduced from one region of the holographic recording medium, the aperture is moved according to a rotation of the rotating holographic recording medium.

2. The apparatus of claim 1, wherein the aperture is moved to maintain a fixed position with the rotating holographic recording medium.

3. The apparatus of claim 1, wherein after the recording and/or reproducing of the information in the one region is completed, the aperture returns to an initial position to perform recording and/or reproducing of additional information in a next region.

4. The apparatus of claim 1, wherein the signal beam component comprises:
a spatial light modulator to modulate the one light beam into the signal beam having a two-dimensional signal pattern;
a second beam splitter to transmit the one light beam emitted from the first beam splitter toward the spatial light modulator and to transmit the signal beam emitted from the spatial light modulator toward the holographic recording medium; and
an objective lens to focus the signal beam incident on the holographic recording medium.

5. The apparatus of claim 4, wherein the aperture is located along the optical path of the signal beam between the second beam splitter and the objective lens.

6. The apparatus of claim 4, wherein the second beam splitter transmits the signal beam reproduced from the holographic recording medium toward the two-dimensional photodetector.

7. The apparatus of claim 1, wherein the two-dimensional photodetector is a CCD (charge coupled device).

8. The apparatus of claim 1, wherein the two-dimensional photodetector comprises a plurality of photodiodes arranged in an array.

9. The apparatus of claim 1, wherein the aperture is a liquid crystal aperture in which a light transmission region is moved so that the light transmission region maintains a fixed position relative to the rotating holographic recording medium.

10. The apparatus of claim 1, wherein the aperture is a rotating disc comprising a plurality of openings formed along a circumferential direction of the rotating disc at predetermined intervals.

11. The apparatus of claim 10, wherein the plurality of openings are formed to correspond to a plurality of information recording regions on the holographic recording medium so that the plurality of openings continuously coincides with the plurality of information recording regions.

12. The apparatus of claim 1, wherein the aperture comprises:
a flat board having an opening; and
an actuator to reciprocate the flat board so that the opening maintains a fixed position relative to the rotating holographic recording medium.

13. The apparatus of claim 1, wherein the holographic recording medium is split into a plurality of information recording regions, and a prepit indicating a movement start time for the aperture is marked in each of the information recording regions.

14. The apparatus of claim 13, further comprising an aperture controller to control the movement of the aperture by detecting the prepit marks marked in each of the information recording regions of the holographic recording medium.

15. The apparatus of claim 14, wherein the aperture controller comprises:
an auxiliary light source to emit an auxiliary light beam to detect the prepit marks;
a photodetector to detect the prepit marks from the auxiliary light beam reflected by the holographic recording medium;
a third beam splitter to transmit the auxiliary light beam from the auxiliary light source toward the holographic recording medium and to transmit the auxiliary light beam reflected from the holographic recording medium toward the photodetector; and
an aperture driver to drive the aperture when each of the prepit marks is detected by the photodetector.

16. The apparatus of claim 15, wherein the aperture controller further comprises a fourth beam splitter to transmit the auxiliary light beam emitted from the auxiliary light source along the optical path of the signal beam.

17. The apparatus of claim 15, wherein the photodetector is a photodiode.

18. The apparatus of claim 1, wherein the aperture has a width which is substantially the same as a width of the one region.

19. A method to record and/or reproduce holographic information using an apparatus to record and/or reproduce holographic information to and/or from a rotating holographic recording medium, the apparatus including an aperture to restrict a width of a signal beam, the method comprising:
rotating the holographic recording medium;
moving the aperture according to a rotation of the rotating holographic recording medium while information is recorded and/or reproduced to and/or from one information recording region of the holographic recording medium; and
returning the aperture to an initial position after the recording and/or reproducing of the information to and/or from the one region is completed, to perform recording and/or reproducing of additional information to and/or from a next information recording region.

20. The method of claim 19, wherein the aperture is moved to maintain a fixed position with the rotating holographic recording medium.

21. The method of claim 19, wherein the aperture is a liquid crystal aperture in which a light transmission region is moved so that the light transmission region maintains a fixed position relative to the rotating holographic recording medium.

22. The method of claim 19, wherein the aperture is a rotating disc comprising a plurality of openings formed along a circumferential direction of the rotating disc at predetermined intervals.

23. The method of claim 19, wherein the aperture comprises:
a flat board having an opening; and
an actuator to reciprocate the flat board so that the opening maintains a fixed position relative to the rotating holographic recording medium.

24. The method of claim 19, wherein the holographic recording medium is split into a plurality of information recording regions, and a prepit indicating a movement start time of the aperture is marked in each of the information recording regions.

25. The method of claim 24, wherein if one of the prepit marks is detected in one of the information recording regions of the holographic recording medium, the aperture is moved.

26. The method of claim 19, wherein the aperture has a width which is substantially the same as a width of the one region.
